(19) United States
(12) Patent Application Publication
(10) Pub. No.: US 2018/0253274 A1
(43) Pub. Date: Sep. 6, 2018

(54) Method for Muting and Electronic Device

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Ruotao WANG, BEIJING (CN)

(21) Appl. No.: 15/120,320

(22) PCT Filed: May 26, 2016
(86) PCT No.: PCT/CN2016/083544

§ 371 Date: Aug. 19, 2016

(30) Foreign Application Priority Data
Nov. 26, 2015 (CN) 201510844865.0

(51) Int. Cl. G06F 3/16; G06F 17/30

(52) U.S. Cl. CPC G06F 3/165; G06F 17/30241

(57) ABSTRACT

Disclosure is a method for muting and an electronic device, comprising: detecting the sound playing status and location information, after receiving an instruction of playing a program by a user; pausing the program and prompting the user, if a loudspeaker volume mode is enable and a scene requiring quiet is located in; and disabling the loudspeaker volume mode at the program playing, if the instruction of disabling the loudspeaker volume is received.

### CROSS REFERENCE TO RELATED APPLICATIONS

This application is a continuation of International Application No. PCT/CN2016/083544, with an international filing date of filed May 26, 2016, which is based upon and claims priority to Chinese Patent Application No. 201510844865.0, filed on Nov. 26, 2015, the entire contents of all of which are incorporated herein by reference.

### TECHNICAL FIELD

The present invention relates to multimedia technology, in particular to a method for muting and an electronic device.

### BACKGROUND

Playing of music, video or other multimedia is a common relax way for people. There are inexhaustible variety of multimedia player software and a wide range of multimedia players, including recorder, Walkman, MP3, MP4, computer, etc., and now, a smart phone integrated with multimedia playback, communication, camera and other functions is the most commonly used electronic device.

Electronic device is provided with a loudspeaker, but when the multimedia player software is opened to play audio or video at a relatively quiet scene such as library, classroom, office, cafes, cinema, conference room and the like, users often forget the volume setting status (muting or not, etc.), resulting in the problem that it occurred of sounding in public to cause a sudden sound at the playback of video or audio.

### SUMMARY

In view of this, an object of the invention is to propose a method for muting and an electronic device to prevent the electronic device from a sudden sound at a scene needed to be quiet.

Based on the object, as an embodiment, the present invention provides a method for muting, comprising:

detecting the sound playing status and location information, after receiving an instruction of playing a program by a user;

pausing the program and prompting the user, if a loudspeaker volume mode is enable and a scene requiring quiet is located in; and

disabling the loudspeaker volume mode at the program playing, if the instruction of disabling the loudspeaker volume is received.

In another aspect of the present invention, it is provided a terminal device for muting, which as an embodiment comprises:

a detection module, for detecting the sound playing status and location information, after receiving an instruction of playing a program by a user;

a prompting module, for pausing the program and prompting the user, if a loudspeaker volume mode is enable and a scene requiring quiet is located in; and

a playing module, for disabling the loudspeaker volume mode at the program playing, if the instruction of disabling the loudspeaker volume is received.

In a further another aspect of an embodiment of the present invention, it is provided an electronic device, comprising:

at least processor; and

a memory communicably connected with the at least one processor for storing instructions executable by the at least one processor, wherein execution of the instructions by the at least one processor causes the at least one processor to:

detect the sound playing status and location information, after receiving an instruction of playing a program by a user;

pause the program and prompting the user, if a loudspeaker volume mode is enable and a scene requiring quiet is located in; and

disable the loudspeaker volume mode at the program playing, if the instruction of disabling the loudspeaker volume is received.

In a further another aspect of an embodiment of the present invention, it is provided a non-transitory computer-readable storage medium storing executable instructions that, when executed by an electronic device with a touch-sensitive display, cause the electronic device to:

detect the sound playing status and location information, after receiving an instruction of playing a program by a user;

pause the program and prompting the user, if a loudspeaker volume mode is enable and a scene requiring quiet is located in; and

disable the loudspeaker volume mode at the program playing, if the instruction of disabling the loudspeaker volume is received.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a method for muting according to an embodiment of the present invention;

FIG. 2 is a schematic flow diagram of a method for muting according to another embodiment of the present invention;

FIG. 3 is a schematic flow diagram of a method for muting according to further another embodiment of the present invention;

FIG. 4 is a schematic view of a terminal device for muting according to an embodiment of the present invention;

FIG. 5 is a schematic view of a terminal device for muting according to another embodiment of the present invention;

FIG. 6 is a schematic view of a terminal device for muting according to further another embodiment of the present invention.

### DETAILED DESCRIPTION

The present invention is described more fully hereinafter with reference to the accompanying drawings so that the objects, technical solutions and advantages of the present invention will become clearer and more apparent.

When opening a multimedia player software to play a video or audio at a relatively quiet scene such as library, classroom, office, cafes, cinema, conference room, etc., because people often forget the volume status (muting or not, etc.), it occurred a problem of sounding in public to cause a sudden sound at the playing of video or audio. To address this problem, embodiments of the present invention provide a method for automatic muting at the playing of audio or video, including: detecting the sound playing status and location information, after receiving an instruction of playing a program by a user; pausing the program and prompting the user, if a loudspeaker volume mode is enable and a scene requiring quiet is located in; and disabling the loudspeaker volume mode at the program playing, if the instruction of disabling the loudspeaker volume is received. The method analyzes whether the location of the electronic device is at a scene requiring quiet to determine whether it uses muting mode to play, so as to prevent the electronic device from unexpectedly sound at a scene requiring quiet and impolite disturbance of other people.

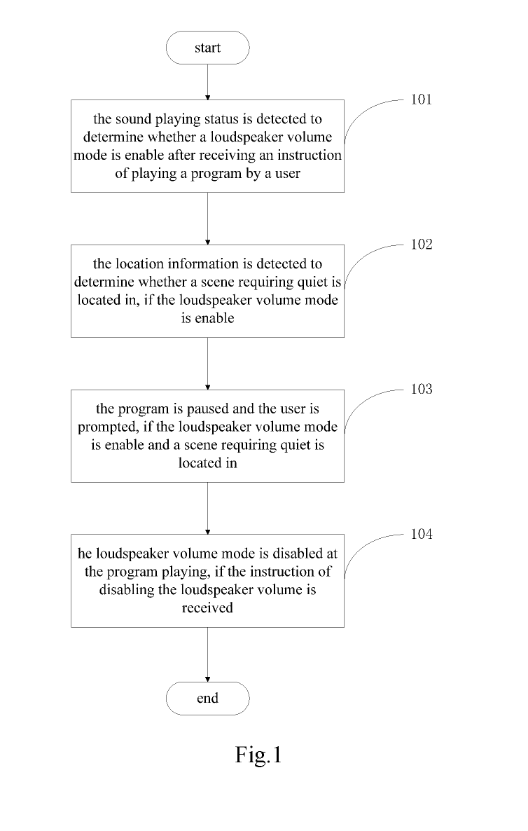

Referring to FIG. 1, it is a schematic flow diagram of a method for muting according to an embodiment of the present invention, as an embodiment of the present invention, the method for muting including:

In step 101, the sound playing status is detected to determine whether a loudspeaker volume mode is enable after receiving an instruction of playing a program by a user.

In this step, a user opens a multiplayer to play a program and an electronic device receives the instructions of playing programs by the user. The sound playing status of the electronic device is detected to determine whether the electronic device is in a loudspeaker volume mode, after receiving an instruction of playing a program by a user. The program means a multimedia such as video or audio, etc., which will sound via the loudspeaker.

In step 102: the location information is detected to determine whether a scene requiring quiet is located in, if the loudspeaker volume mode is enable.

Specifically, if the electronic device is in a loudspeaker volume mode, the location information of the electronic device will be detected to determine whether the electronic device is at a scene requiring quiet.

It should be noted that, in the embodiment of the present invention, the scene requiring quiet means any one of library, classroom, office, cafes, cinema, conference room, etc., which is relative quieter and requests people to keep quiet, so that it will disturb other people if the electronic device sounds at such a scene.

In an alternative embodiment of the present invention, the location information may be a latitude-longitude coordinate or an IP address.

As an example, in an alternative embodiment, the detecting the location information to determine whether a scene requiring quiet is located in includes determining whether a scene requiring quiet is located in by positioning a coordinate of the location through GPS positioning and matching the current location in an electronic map database based on the coordinate of the location. Alternatively, in this step, it acquires the current latitude-longitude coordinate of the electronic device from a GPS sensor, and the current location is matched in an electronic map database based on the latitude-longitude coordinate to determine whether a scene requiring quiet is located in. The latitude-longitude coordinates of the scenes requiring quiet can be pre-stored to facilitate to match the location of the electronic device with the scenes requiring quiet to determine whether the electronic device is at a scene requiring quiet currently. In this example, even if the electronic device is not connected with network, it also can be positioned via GPS to avoid the limitation of network connection.

In another alternative embodiment of the invention, the detecting the location information to determine whether a scene requiring quiet is located in includes acquiring an IP address of a network current connected, and matching the IP address with IP addresses pre-stored in a database of scenes requiring quiet to determine whether the current IP address is in a scene requiring quiet. Alternatively, the IP addresses of the scenes requiring quiet can be pre-stored in the database of scenes requiring quiet to facilitate to match the IP address of the electronic device with the IP addresses of the scenes requiring quiet, so as to determine whether the electronic device is located in a scene requiring quiet. Specifically, the method includes acquiring the IP address of a network current connected; matching the current IP address with the IP address in a database of scenes requiring quiet to determine whether the current IP address is an IP address of the scene requiring quiet, so as to determine whether the electronic device is located in a scene requiring quiet. In this example, the electronic device has to connect with network, for example, it needs to be working in the circumstances of WIFI, 3G or 4G network. Alternatively, the database of scenes requiring quiet is stored in the network server end.

In an alternative example of the invention, the method further includes: receiving an instruction of adding a new IP address into the scene database of scenes requiring quiet; extracting the IP address of the network currently connected as a new-added IP address; and sending it to the database of scenes requiring quiet. In this example, if the current IP address of electronic device does not match with the IP address in the database of scenes requiring quiet, the IP address can be further added into the database of scenes requiring quiet to update the database to improve the accuracy of the determination of the scenes requiring quiet. Specifically, if a user triggers an instruction of adding a new IP address into the database of scenes requiring quiet; after receiving the user's instruction of adding a new IP address into the quiet scene database; the IP address of the network current connected is extracted as a new-added IP address; and sending it to the database of scenes requiring to update the database.

Alternatively, the database of scenes requiring quiet is stored in the network server end, and after the new-added IP address is send to the database of scenes requiring quiet, the method further includes: after the network server ends receiving the new-added IP address, determining whether the new-added IP address is received before and whether the frequency exceeds a preset frequency threshold, if the new-added IP address is received before and the frequency exceeds a preset frequency threshold, storing the new-added IP address in the database of scenes requiring quiet as the IP address of the scene requiring quiet. It should be noted that, the frequency threshold of receiving new IP address can be set in the network server ends, such as 3, 5 or other times. If the times of the network server ends receiving a new IP address exceeds the threshold, the new IP address is stored as an IP address of the scenes requiring quiet into the database of scenes requiring quiet.

In step 103: the program is paused and the user is prompted, if the loudspeaker volume mode is enable and a scene requiring quiet located in.

Specifically, if the electronic device is in the loudspeaker volume mode and located in a scene requiring quiet, the program is paused, and at the same time, the user is prompted whether to make a loudspeaker volume mode enable; if it is determined that the electronic device is not located at a scene requiring quiet, the program is played.

In an alternative embodiment of the invention, when pausing the program, a prompt window displaying whether the loudspeaker volume is opened can be overlapped on the interface of playing the stream media program, to prompt the user whether to open the loudspeaker volume. Alternatively, the form of prompt window includes translucent with all coverage, opaque with partially coverage or translucent with partially coverage. If the electronic device is not in a loudspeaker volume mode, regardless that the loudspeaker is closed or a headset is inserted into a headset jack of the electronic device, the program can be played.

In step 104: the loudspeaker volume mode is disabled at the program playing, if the instruction of disabling the loudspeaker volume is received.

In an embodiment of the invention, the disabling the loudspeaker volume at the program playing is to resume playing the program in muting mode. In this step, the electronic device receives the user's instruction of disabling the loudspeaker volume, controlling the program to be played in muting mode, that is, closing the loudspeaker, so as to avoid a sudden sound of the electronic device at a scene requiring quiet. On the contrary, if the electronic device receives the user's instruction of enabling the loudspeaker volume, playing the program. Corresponding to Step 103, the user can select whether triggering the instruction of disabling the loudspeaker volume on the prompt window of whether enabling the loudspeaker volume.

In another alternative embodiment of the present invention, if receiving the user's instruction of enabling the loudspeaker volume, playing the program in a volume before the pause and the user does not have to adjust the playback volume again.

Furthermore, in an alternative embodiment of the invention, at the program playing in muting mode, the method further includes: detecting whether a headset is plugged into a headset jack; if a headset is plugged into a headset jack, playing the program. Alternatively, when detecting out there is a headset in a headset jack, playing the program in a volume before the pause.

Specifically, as an example of the present invention, whether there is an headset in an headset jack can be determined by: detecting the voltage of headset detection pin HEADSET_DET, determining the level. The pin HEADSET_DET is defined as a headset detection pin which is GPIO pin, namely a general input and output pin. When an headset is not plugged into the electronic device, the pin HEADSET_DET is in suspension to be a higher level. When an headset is plugged into the electronic device, the pin HEADSET_DET is connected with the headset to be a lower level. The level of the pin HEADSET_DET can be detected, when the pin HEADSET_DET is a higher level, determining as a non-plugged status and at this time the headset is not plugged into the electronic device and the audio channel of the electronic device is in a loudspeaker mode; when the pin HEADSET_DET is a lower level, determining as a plugged status, and at this time the headset is plugged into the electronic device and the audio channel is switched into a headset mode. When determining that a headset is plugged into the electronic device, the program is played in a volume before the pause.

In an alternative embodiment of the invention, at the program playing in muting mode, the method further includes: determining whether a scene requiring quiet is located in; if a scene requiring quiet is not located in, playing the program. Alternatively, it is alternative to play the program in a volume before the pause, so that the user does not have to adjust the volume. Alternatively, at the program playing in a muting mode, the location of the electronic device may be changed, so that it is alternative to determine whether the electronic device is at a scene requiring quiet in real-time; if the electronic device is not at a scene requiring quiet in real-time, playing the program in a volume before the pause; if the electronic device is at a scene requiring quiet in real-time, keeping to disable the loudspeaker volume.

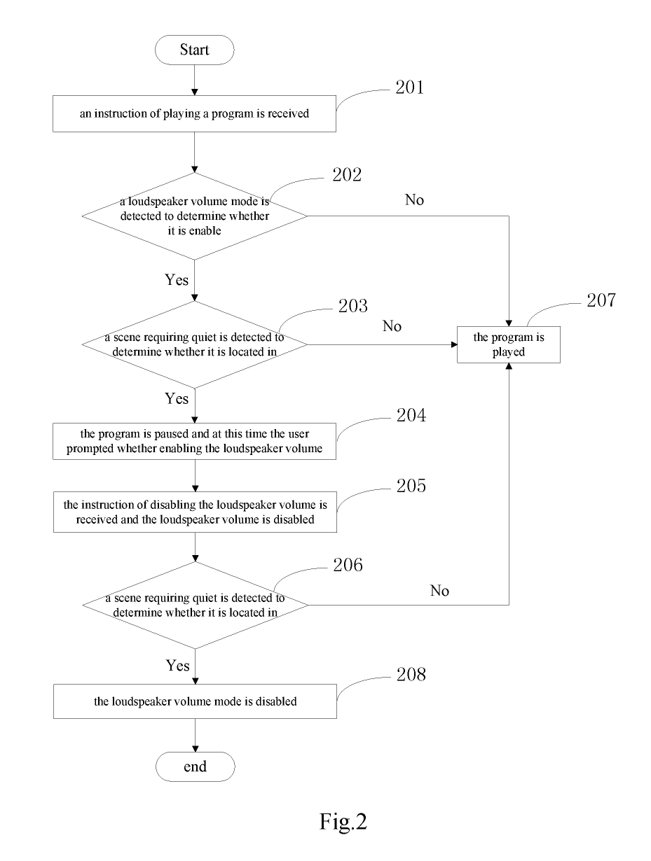

Hereinafter, the method will be further described in detail by an alternative example of the invention, as shown in FIG.2, the method in the example mainly including:

In step 201: an instruction of playing a program is received;

In step 202: a loudspeaker volume mode is detected to determine whether it is enable; if a loudspeaker volume mode is not enable, step 207 is executed, meaning that a headset is plugged into a headset jack, even if play sound, it would not disturb people;

In step 203: a scene requiring quiet is detected to determine whether it is located in; if a scene requiring quiet is not located in, step 207 is executed; if a scene requiring quiet is located in, step 204 is executed; in this step, whether the electronic device is at a scene requiring quiet can be determined by positioning the location of the electronic device through GPS positioning; or it can acquire an IP address of a network current connected of the electronic device to determine whether the current IP address is in a scene requiring quiet by matching the IP address with IP addresses pre-stored in a database of scenes requiring quiet, in order to be convenient and quick to determine whether the electronic device is at a scene requiring quiet or not;

In step 204: the program is paused and at this time the user prompted whether enabling the loudspeaker volume; it means that the electronic device is in a loudspeaker volume mode and at a scene requiring quiet;

In step 205: the instruction of disabling the loudspeaker volume is received and the loudspeaker volume is disabled;

In step 206: a scene requiring quiet is detected to determine whether it is located in; if a scene requiring quiet is not located in, step 207 is executed; if a scene requiring quiet is located in, step 208 is executed;

In step 207: the program is played;

In step 208: the loudspeaker volume mode is disabled.

Alternatively, the disabling the loudspeaker volume mode includes resuming playing the program in a muting mode.

In an example of the invention, step 207 can includes playing the program in a volume before the pause.

As an alternative example of the invention, step 206 can be replaced with: a headset is detected to determine whether it is plugged into a headset jack; if a headset is not plugged into a headset jack, step 208 is executed; if a headset is plugged into a headset jack, step 207 is executed.

As an alternative example of the invention, step 206 can be replaced with: a scene requiring quiet is detected to determine whether it is located in real-time and a headset is detected to determine whether it is plugged into the headset jack; if a scene requiring quiet is located in without detecting a plugged headset, step 208 is executed; otherwise, step 207 is executed.

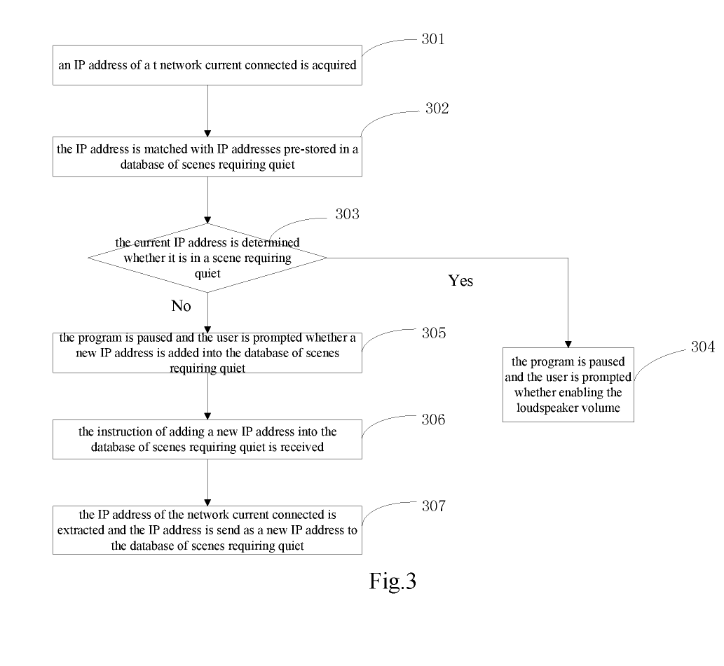

As shown in FIG. 3, as an alternative example of the invention, in the example of determining whether a scene requiring quiet is located in by IP address, the method provided by the invention further includes:

In step 301: an IP address of a t network current connected is acquired;

In step 302: the IP address is matched with IP addresses pre-stored in a database of scenes requiring quiet;

In step 303: the current IP address is determined whether it is in a scene requiring quiet; if the current IP address is in a scene requiring quiet, step 304 is executed; if the current IP address is not in a scene requiring quiet, step 305 executed;

In step 304: the program is paused and the user is prompted whether enabling the loudspeaker volume;

In step 305: the program is paused and the user is prompted whether a new IP address is added into the database of scenes requiring quiet;

In step 306: the instruction of adding a new IP address into the database of scenes requiring quiet is received;

In step 307: the IP address of the network current connected is extracted and the IP address is send as a new IP address to the database of scenes requiring quiet.

The new-added IP address received by the network server is stored in the database of scenes requiring quiet as an IP address of the scenes requiring quiet, so that the database of scenes requiring quiet can be updated to improve the accuracy of determining the scenes requiring quiet.

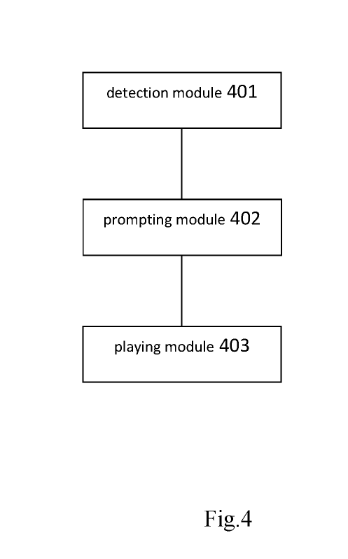

The present invention also provides a terminal device for muting, as shown in FIG. 4, the terminal device including:

a detection module 401, for detecting the sound playing status and location information, after receiving an instruction of playing a program by a user;

a prompting module 402, for pausing the program and prompting the user, if a loudspeaker volume mode is enable and a scene requiring quiet is located in; and

a playing module 403, for disabling the loudspeaker volume mode at the program playing, if the instruction of disabling the loudspeaker volume is received.

As another embodiment of the invention, the detection module 401 includes:

a loudspeaker detection module, for detecting the sound playing status to determine whether the loudspeaker volume mode is enable, after receiving the instruction of playing the program, as described in the above-mentioned examples; and

a scene detection module, for detecting the location information to determine whether a scene requiring quiet is located in, if the loudspeaker volume mode is enable, as described in the above-mentioned examples.

In an alternative embodiment of the present invention, the scene detection module determines whether the current location is in a scene requiring quiet by positioning a coordinate of the location through GPS positioning and matching the current location in an electronic map database based on the coordinate of the location, as described in the above-mentioned examples. In another embodiment of the present invention, scene detection module acquires a IP address of a network currently connected and determines whether a scene requiring quiet is locate in by matching the IP address with IP addresses pre-stored in the database of scenes requiring quiet, as described in the above-mentioned examples.

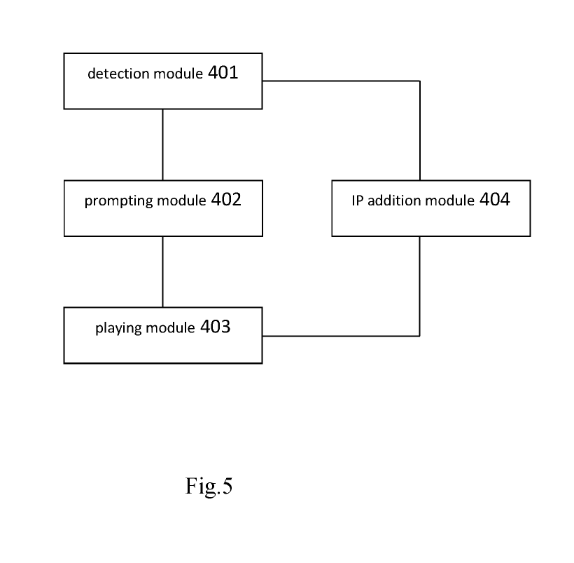

In an alternative embodiment of the present invention, as shown in FIG. 5, the terminal device also can include an IP addition module 404, for receiving the instruction of adding a new IP address into the database of scenes requiring quiet and extracting the IP address of the network currently connected and sending the IP address of the network as a new-added IP address to the database, as described in the above-mentioned examples.

In an alternative embodiment of the present invention, the quiet scene database is stored in a network server end, and after receiving the new-added IP address, the network server ends determine whether the new-added IP address is received before and the frequency exceeds a preset frequency threshold; if the new-added IP address is received before and the frequency exceeds a preset frequency threshold, storing the new-added IP address into the database of scenes requiring quiet as the IP address of the scenes requiring quiet, as described in the above-mentioned examples.

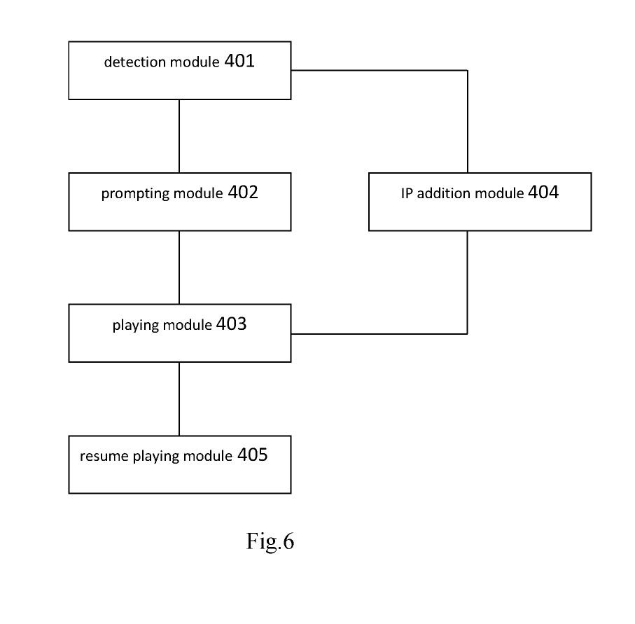

In another embodiment of the present invention, as shown in FIG. 6, the playing module disables the loudspeaker volume is to resume playing the program in a muting mode, and the terminal device also includes a resume playing module 405, at the program playing in a muting mode, for detecting whether a headset is plugged into a headset jack; if a headset is plugged into a headset jack, playing the program in a volume before the pause; and/or determining whether a scene requiring quiet is located in; if the scenes requiring quiet is not located in, playing the program in a volume before the pause, as described in the above-mentioned examples.

The present invention also provides an electronic device, including:

at least processor; and

a memory communicably connected with the at least one processor for storing instructions executable by the at least one processor, wherein execution of the instructions by the at least one processor causes the at least one processor is to:

detect the sound playing status and location information, after receiving an instruction of playing a program by a user;

pause the program and prompting the user, if a loudspeaker volume mode is enable and a scene requiring quiet is located in; and

disable the loudspeaker volume mode at the program playing, if the instruction of disabling the loudspeaker volume is received.

In some embodiments of the present invention, the at least one processor is further caused to:

detect the sound playing status to determine whether the loudspeaker volume mode is enable; and

detect the location information to determine whether a scene requiring quiet is located in, if the loudspeaker volume mode is enable.

In some embodiments of the present invention, the electronic device further includes a GPS sensor for acquiring a coordinate of the location and the at least one processor is further caused to:

determine whether a scene requiring quiet is located in by matching the current location in an electronic map database based on the coordinate of the location.

In some embodiments of the present invention, the at least one processor is caused to:

acquire a IP address of a network currently connected and matching the IP address with IP addresses pre-stored in a database of scenes requiring quiet to determine whether the current IP address is in a scene requiring quiet.

In some embodiments of the present invention, the at least one processor is further caused to:

receive the instruction of adding a new IP address into the database of scenes requiring quiet; and

extract the IP address of the network currently connected and sending the IP address of the network as a new-added IP address to the database.

In some embodiments of the present invention, the database of scenes requiring quiet is stored in a network server end, and the at least one processor is further caused to:

send the new-added IP address to the network server end, and the network server end determining whether the new-added IP address is received before and whether the frequency exceeds a preset frequency threshold; if the new-added IP address is received before and the frequency exceeds a preset frequency threshold, store the new-added IP address into the database of scenes requiring quiet as the IP address of the scenes requiring quiet.

In some embodiments of the present invention, the disabling the loudspeaker volume at the program playing is to resume playing the program in a muting mode, and at the program playing in a muting mode, the at least one processor is further caused to:

detect whether a headset is plugged into a headset jack; if a headset is plugged into a headset jack, playing the program in a volume before the pause; and/or

determine whether a scene requiring quiet is located in; if the scenes requiring quiet is not located in, playing the program in a volume before the pause.

In a further another aspect of an embodiment of the present invention, it is provided a non-transitory computer-readable storage medium storing executable instructions that, when executed by an electronic device with a touch-sensitive display, cause the electronic device to:

detect the sound playing status and location information, after receiving an instruction of playing a program by a user;

pause the program and prompting the user, if a loudspeaker volume mode is enable and a scene requiring quiet is located in; and

disable the loudspeaker volume mode at the program playing, if the instruction of disabling the loudspeaker volume is received.

In some embodiments of the present invention, the electronic device is further caused to:

detect the sound playing status to determine whether the loudspeaker volume mode is enable; and

detect the location information to determine whether a scene requiring quiet is located in, if the loudspeaker volume mode is enable.

In some embodiments of the present invention, the electronic device further comprises a GPS sensor for acquiring a coordinate of the location and the electronic device is further caused to:

determine whether a scene requiring quiet is located in by matching the current location in an electronic map database based on the coordinate of the location.

In some embodiments of the present invention, the electronic device is further caused to:

acquire an IP address of a network currently connected and matching the IP address with IP addresses pre-stored in a database of scenes requiring quiet to determine whether the current IP address is in a scene requiring quiet.

In some embodiments of the present invention, the electronic device is further caused to:

receive the instruction of adding a new IP address into the database of scenes requiring quiet; and

extract the IP address of the network currently connected and sending the IP address of the network as a new-added IP address to the database.

In some embodiments of the present invention, the disabling the loudspeaker volume mode at the program playing is to resume playing the program in a muting mode, and at the program playing in a muting mode, the electronic device is further caused to:

detect whether a headset is plugged into a headset jack; if a headset is plugged into a headset jack, playing the program in a volume before the pause; and/or

determine whether a scene requiring quiet is located in; if the scenes requiring quiet is not located in, playing the program in a volume before the pause.

As can be seen from the description, the method for muting and electronic device provided by the embodiments of the present invention can control whether the program is played in a muting mode by determining whether the electronic device is in a scene requiring quiet, so that when the electronic device is in a scene requiring quiet, it can automatically play in a muting mode. Therefore, the method can determine whether playing in a muting mode by analyzing whether the location of the electronic device is in a scene requiring quiet, to avoid the electronic device from making a sudden sound in a scene requiring quiet to disturb other people or be impolite.

In addition, typically, the device of the present disclosure can be a variety of electronic devices such as mobile phone, personal digital assistant (PDA), tablet PC (PAD), smart TV, etc., so that the scope of the disclosure should not be limited to a specific type of electronic device. The system of the present disclosure can be applied in any one of the above electronic devices in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As a example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user electronic. In an alternative, the processor and the storage medium may reside as discrete components in a user electronic.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and blue-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intention of implying that the scopes of the present disclosure (including claims) are limited to these examples; the embodiments or the features in the different embodiments may be combined and the steps may be implemented in any order in accordance with the idea of the present invention, and there are many other variations of the different aspects of the present invention as described herein without description in the details for simplicity. Thus, any omissions, modifications, equivalent replacements and improvements made in the spirit and principles of the present invention should be included within the scope of the present invention.

What is claimed is:

1. A method for muting, comprising:
detecting the sound playing status and location information, after receiving an instruction of playing a program by a user;
pausing the program and prompting the user, if a loudspeaker volume mode is enable and a scene requiring quiet is located in; and
disabling the loudspeaker volume mode at the program playing, if the instruction of disabling the loudspeaker volume is received.

2. The method according to claim 1, wherein the detecting the sound playing status and location information comprises:
detecting the sound playing status to determine whether the loudspeaker volume mode is enable; and
detecting the location information to determine whether a scene requiring quiet is located in, if the loudspeaker volume mode is enable.

3. The method according to claim 2, wherein the detecting the location information to determine whether a scene requiring quiet is located in comprises:
determining whether a scene requiring quiet is located in by positioning a coordinate of the location through GPS positioning and matching the current location in an electronic map database based on the coordinate of the location.

4. The method according to claim 2, wherein the detecting the location information to determine whether a scene requiring quiet is located in comprises:
acquiring an IP address of a network currently connected and matching the IP address with IP addresses pre-stored in a database of scenes requiring quiet to determine whether the current IP address is in a scene requiring quiet.

5. The method according to claim 4, wherein the method further comprises:
receiving the instruction of adding a new IP address into the database of scenes requiring quiet; and
extracting the IP address of the network current connected and sending the IP address of the network as a new-added IP address to the database.

6. The method according to claim 5, wherein the database of scenes requiring quiet is stored in a network server end, and after the sending the new-added IP address to the database of scenes requiring quiet, the method further comprises:
after the network server ends receiving the new-added IP address, determining whether the new-added IP address is received before and whether the frequency exceeds a preset frequency threshold; if the new-added IP address is received before and the frequency exceeds a preset frequency threshold, storing the new-added IP address into the database of scenes requiring quiet as the IP address of the scenes requiring quiet.

7. The method according to claim 1, wherein the disabling the loudspeaker volume mode at the program playing is to resume playing the program in a muting mode, and at the program playing in a muting mode, the method further comprises:
detecting whether a headset is plugged into a headset jack; if a headset is plugged into a headset jack, playing the program in a volume before the pause; and/or
determining whether a scene requiring quiet is located in; if the scenes requiring quiet is not located in, playing the program in a volume before the pause.

8. An electronic device, comprising:
at least one processor; and
a memory communicably connected with the at least one processor for storing instructions executable by the at least one processor, wherein execution of the instructions by the at least one processor causes the at least one processor to:
detect the sound playing status and location information, after receiving an instruction of playing a program by a user;
pause the program and prompting the user, if a loudspeaker volume mode is enable and a scene requiring quiet is located in; and
disable the loudspeaker volume mode at the program playing, if the instruction of disabling the loudspeaker volume is received.

9. The electronic device according to claim 8, wherein the at least one processor is further caused to:
detect the sound playing status to determine whether the loudspeaker volume mode is enable; and
detect the location information to determine whether a scene requiring quiet is located in, if the loudspeaker volume mode is enable.

10. The electronic device according to claim 9, wherein the electronic device further comprises a GPS sensor for acquiring a coordinate of the location and the at least one processor is further caused to:
determine whether a scene requiring quiet is located in by matching the current location in an electronic map database based on the coordinate of the location.

11. The electronic device according to claim 9, wherein the at least one processor is further caused to:
acquire an IP address of a network currently connected and matching the IP address with IP addresses pre-stored in a database of scenes requiring quiet to determine whether the current IP address is in a scene requiring quiet.

12. The electronic device according to claim 11, wherein the at least one processor is further caused to:
receive the instruction of adding a new IP address into the database of scenes requiring quiet; and
extract the IP address of the network currently connected and sending the IP address of the network as a new-added IP address to the database.

13. The electronic device according to claim 12, wherein the database of scenes requiring quiet is stored in a network server end, and the at least one processor is further caused to:
send the new-added IP address to the network server end, and the network server end determining whether the new-added IP address is received before and whether the frequency exceeds a preset frequency threshold; if the new-added IP address is received before and the frequency exceeds a preset frequency threshold, store the new-added IP address into the database of scenes requiring quiet as the IP address of the scenes requiring quiet.

14. The electronic device according to claim 8, wherein the disabling the loudspeaker volume mode at the program playing is to resume playing the program in a muting mode, and at the program playing in a muting mode, the at least one processor is further caused to:
detect whether a headset is plugged into a headset jack; if a headset is plugged into a headset jack, playing the program in a volume before the pause; and/or
determine whether a scene requiring quiet is located in; if the scenes requiring quiet is not located in, playing the program in a volume before the pause.

15. A non-transitory computer-readable storage medium storing executable instructions that, when executed by an electronic device with a touch-sensitive display, cause the electronic device to:
detect the sound playing status and location information, after receiving an instruction of playing a program by a user;
pause the program and prompting the user, if a loudspeaker volume mode is enable and a scene requiring quiet is located in; and
disable the loudspeaker volume mode at the program playing, if the instruction of disabling the loudspeaker volume is received.

16. The electronic device according to claim 15, wherein the electronic device is further caused to:
detect the sound playing status to determine whether the loudspeaker volume mode is enable; and
detect the location information to determine whether a scene requiring quiet is located in, if the loudspeaker volume mode is enable.

17. The electronic device according to claim 16, wherein the electronic device further comprises a GPS sensor for acquiring a coordinate of the location and the electronic device is further caused to:
determine whether a scene requiring quiet is located in by matching the current location in an electronic map database based on the coordinate of the location.

18. The electronic device according to claim 16, wherein the electronic device is further caused to:
acquire an IP address of a network currently connected and matching the IP address with IP addresses pre-stored in a database of scenes requiring quiet to determine whether the current IP address is in a scene requiring quiet.

19. The electronic device according to claim 18, wherein the electronic device is further caused to:
receive the instruction of adding a new IP address into the database of scenes requiring quiet; and
extract the IP address of the network currently connected and sending the IP address of the network as a new-added IP address to the database.

20. The electronic device according to claim 15, wherein the disabling the loudspeaker volume mode at the program playing is to resume playing the program in a muting mode, and at the program playing in a muting mode, the electronic device is further caused to:
detect whether a headset is plugged into a headset jack; if a headset is plugged into a headset jack, playing the program in a volume before the pause; and/or
determine whether a scene requiring quiet is located in; if the scenes requiring quiet is not located in, playing the program in a volume before the pause.
